(19) United States
(12) Patent Application Publication
(10) Pub. No.: US 2025/0139511 A1
(43) Pub. Date: May 1, 2025

(54) Method and System for a Receiver in a Communication Network

(71) Applicant: Nokia Solutions and Networks Oy, Espoo (FI)

(72) Inventors: Dani Johannes KORPI, Helsinki (FI); Mikko Johannes HONKALA, Espoo (FI); Janne Matti Juhani HUTTUNEN, Espoo (FI); Mikko Aleksi UUSITALO, Helsinki (FI); Jakob HOYDIS, Paris (FR)

(21) Appl. No.: 18/694,083

(22) PCT Filed: Oct. 19, 2022
(86) PCT No.: PCT/EP2022/079089

§ 371 Date: Mar. 21, 2024

(30) Foreign Application Priority Data
Oct. 20, 2021 (FI) 20216080

(51) Int. Cl. G06N 20/00

(52) U.S. Cl. CPC G06N 20/00

(57) ABSTRACT

A method for an apparatus in a communications network is provided. The apparatus includes at least two receiver units configured to receive signals from user equipment (UEs) in the communication network and a logical unit communicatively coupled to each of the receiver units. The logical unit receives a signal from each of the receiver units and output outputs a sequence of data corresponding to a sequence of transmitted data. The method includes receiving a signal at the receiver units and obtaining a sequence of data based on an output of an inference model that is trained to receive an input including a signal received at the receiver units and outputs a sequence of data corresponding to a sequence of transmitted data from a UE. The inference model includes sub-models corresponding to each of the receiver units and a sub-model corresponding to the logical unit.

### TECHNICAL FIELD

The present disclosure relates to methods and systems for training and inference using an inference model at a receiver in a communication network.

### BACKGROUND

In modern telecommunications networks the Radio Access Network (RAN) uses multiple input multiple output (MIMO) technology to enhance capacity of radio links and improve communications. In a MIMO system multiple antennas are deployed at the transmitter and receiver. Signals are propagated between the antenna along multiple paths. Data carried by a signal is split into multiple streams at the transmitter and recombined at the receiver.

Recently, distributed MIMO (dMIMO) has been proposed for deployment in fifth generation (5G) networks. In a dMIMO systems, rather than antennas being co-located in a single receiver, individual signal streams are collected from several radio units (RUs). In particular, in dMIMO systems the antenna array is spatially distributed across multiple RUs.

Another development in recent years is the deployment of machine learning (ML) techniques in the RAN. In applications of ML, a neural network (NN) is trained to learn components of receiver. The learned NN improves both the performance and flexibility of the receiver.

### SUMMARY

It is an object of the invention to provide a method for training an inference model for an apparatus in a communications network.

The foregoing and other objects are achieved by the features of the independent claims. Further implementation forms are apparent from the dependent claims, the description and the figures.

A method for training an inference model for an apparatus in a communications network is provided. The apparatus comprises at least two receiver units configured to receive signals from user equipment (UEs) in the communication network and a logical unit communicatively coupled to each of the at least two receiver units. The logical unit is configured to receive a signal from each of the receiver units and output a sequence of data corresponding to a sequence of transmitted data. The method comprises obtaining a sample from a training dataset, the training dataset comprising sequences of transmitted data values and corresponding signals received at respective receiver units; evaluating the inference model based on the sample and modifying one or more parameters of the inference model based on the evaluation. The inference model comprises sub-models corresponding to each of the at least two receiver units and a sub-model corresponding to the logical unit.

In a first implementation form evaluating the inference model comprises evaluating a loss function based on an output of the inference model and the sequence transmitted data values of the sample.

In a second implementation form the loss function comprises a cross entropy loss function of the output of the inference model and the sequence of transmitted bits.

In a third implementation form modifying one or more parameters of the inference model comprises performing a stochastic gradient descent on the basis of the evaluation.

In a fourth implementation form the inference model comprises a neural network.

The fifth implementation form each of the sub-models comprises a neural network.

In a sixth implementation form the loss function further comprises a mean squared error function of an output of the sub-models of the at least two receiver units and a reference signal.

In a seventh implementation form the reference signal comprises a reference fronthaul signal.

In an eighth implementation form evaluating the inference model comprises evaluating the sub-models corresponding to the at least two receiver units and modifying one or more parameters of the inference model based on the evaluation comprises modifying parameters of the sub-models corresponding to the at least two receiver units based on the evaluation of the respective sub-models.

In a ninth implementation form evaluating the inference model comprises evaluating the sub-model corresponding to the logical unit and modifying one or more parameters of the inference model based on the evaluation comprises modifying parameters of the sub-model corresponding to the logical unit.

In a tenth implementation form the at least two receiver units are distributed receiver units and the logical unit is a distributed unit in a distributed MIMO system.

These and other aspects of the invention will be apparent from and the embodiment(s) described below.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows a receiver node of a communications network, according to an example.

FIG. 2 shows an inference model for a communications network, according to an example.

FIG. 3 shows a training procedure for an inference model, according to an example.

FIG. 4 shows a training procedure for an inference model, according to an example.

FIG. 5 shows a block diagram of a method for training an inference model, according to an example.

FIG. 6 shows a schematic diagram of a computing system, according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

The methods and systems described herein provide an uplink (UL) receiver in the distributed MIMO setting. According to examples a fully learned UL receiver is provided by training a NN jointly for both RUs and a distributed unit (DU) in the dMIMO system.

The learned UL receiver may also be trained to comply with the Open Radio Access Network (ORAN) architecture. ORAN is a framework to facilitate greater vendor interoperability in 5G networks. The ORAN architecture standardizes interfaces between RAN elements such as baseband and RU components.

In cross-vendor scenarios, such as those envisioned by ORAN, the fronthaul communication between RUs and distributed units (DUs) must use a signal from a specific interface. This is likely not the optimal signal to transmit over the fronthaul for a fully learned receiver, as it depends on the processing capabilities of the RUs and DUs. According to examples of the NN may be trained for an ORAN compliant system.

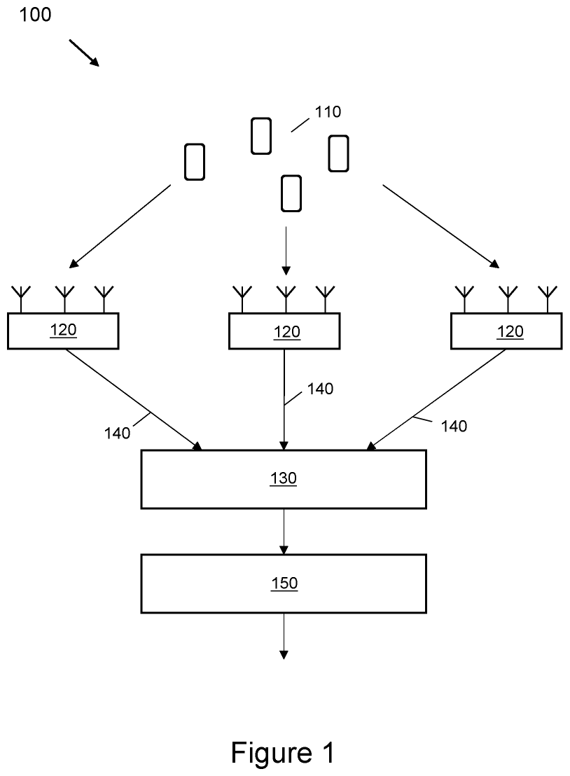

FIG. 1 is a simplified schematic diagram of uplink communication in a RAN 100, according to an example. In FIG. 1, user equipment (UEs) 110 connect to RUs 120. The RUs 120 convert radio signals that are received at antenna from the UEs 110 to digital signals. The RUs 120 are in communication with a DU 130. The DU 130 may implement radio link control (RLC), media access Control (MAC), and Physical (PHY) sublayers.

The RUs 120 communicate with the DU 130 through fronthaul communication links 140. The fronthaul communication link 140 may be a wired enhanced common public radio interface link (eCPRI) link. The DU 130 is communicatively coupled to a channel decoder 150. The channel decoder 150 may be, for example, an low density parity check (LPDC) decoder. The channel decoder may receive data in the form of soft output log-likelihood ratios (LLRs) from the DU 130 and output decoded information bits corresponding to bits encoded in the transmissions of the UEs 110.

According to examples described herein, the methods may be implemented on the systems 100 shown in FIG. 1. In examples, the methods comprise training and inference of an inference model which is learned jointly as a composite machine learning (ML) model for the RUs 120 and DU 130. In particular, backpropagation is done over both the DU 130 and the RUs 120. This ensures that processing carried out in all the different devices is learned optimally from the data.

The joint training ensures that the learned RAN 100 can optimize the end-task of achieving high spectral efficiency without internal processing limitations, beyond the limitations of the fronthaul capacity and hardware requirements. According to examples, the training procedure may take into account the quantization of the fronthaul link 140 by using quantization-aware training to optimize the transmission over the fronthaul under limited precision and bandwidth. Furthermore the same architecture can support an ORAN-compliant fronthaul split, as well as any proprietary split. In this case the training may include an additional regression loss to ensure that the fronthaul signal follows desired specifications.

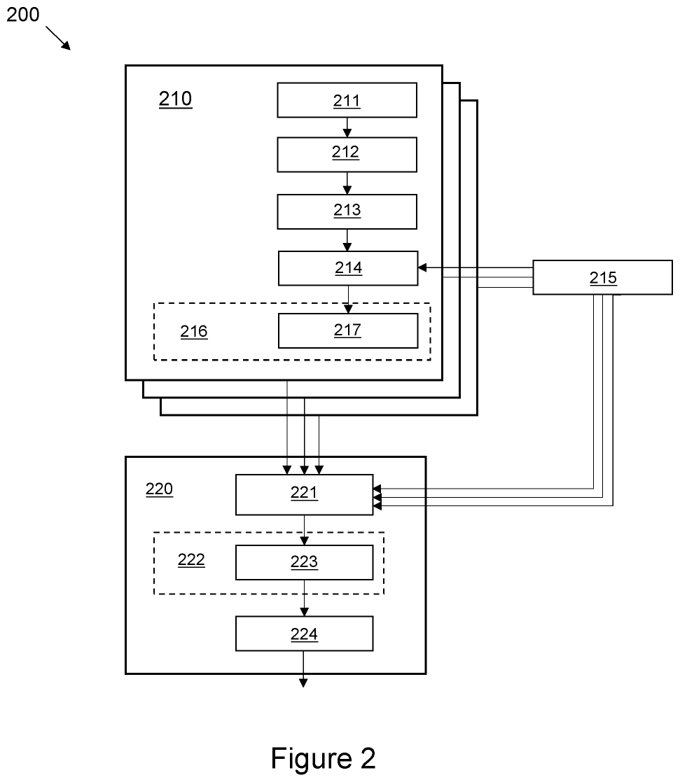

FIG. 2 shows a simplified schematic diagram of an inference model 200, according to an example. The inference model 200 may be used in the RAN 100 shown in FIG. 1, where three RUs 120 are connected to a single DU 120. In other examples more or less RUs 120 may be present. The inference model 200 comprises three components referred to herein as RU DeepRx 210. The RU DeepRx 210 receive time-domain orthogonal frequency-division multiplexing (OFDM) symbols 211 over a single slot, consisting of N_{symb} OFDM symbols. The OFDM symbols 211 undergo cyclic prefix removal 212 and a fast fourier transform (FFT) 213.

ML-based processing occurs in the frequency domain, after CP removal 212 and FFT 213. In addition to the frequency domain signal, the ML input 214 comprises DMRS symbols 215 and information about the layer mapping in each resource element (RE), for example, an integer mask. In the example shown in FIG. 2, each ML RU receiver consists of K ResNet blocks 216, such that the ith block 217 has Ni output channels. The number of output channels from the last ResNet block is Q, the predefined number of streams per RE per RU that can be transmitted over the fronthaul link 140 to the DU 130. These streams may be quantized based on the fronthaul link specifications.

The inference model 200 further comprises a component for the DU 130 referred to herein as the DU DeepRx 220. The DU DeepRx 220 receives individual streams from each RU 120 and continues the processing by concatenating 221 the input streams, along with DMRS and layer information, before feeding them to a neural network. In the example embodiment, a DU neural network receiver is assumed to consist of L ResNet blocks 222, such that the jth block 223 has N; output channels.

The output comprises an array 224 containing log-likelihood ratios (LLRs) for all the layers of all RUs 120. In case there are fewer layers or bits than a maximum allowed, the unused layers and/or bit positions may be set to zero using a binary mask.

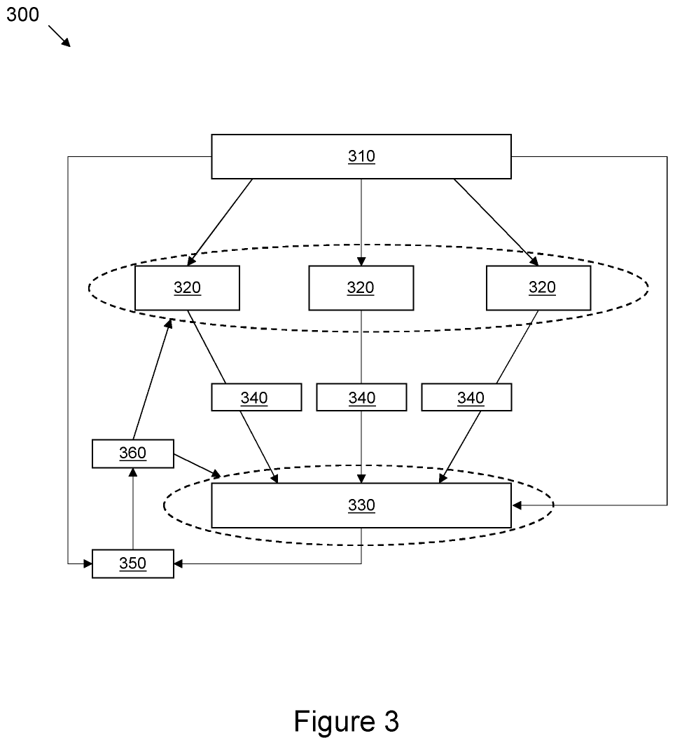

FIG. 3 is a simplified schematic diagram of a training procedure 300 for training of the distributed DeepRx network shown in FIG. 2. The training procedure may be executed by a computing device. In FIG. 1 the fronthaul connection 140 may be bandwidth-limited. This limitation may be hardcoded into the overall inference model as a bottleneck connection between RUs 120 and DU 130. In addition, the quantization of the fronthaul signal is included in the inference model 200 and also during training. The training procedure itself may be carried out with a stochastic gradient descent (SGD) algorithm, using a binary cross entropy (CE) as the loss function. The loss is calculated at the output of the DU DeepRx, while the inputs are the signals fed to the RU DeepRxs. The effect of quantization is included in forward-pass, while it is bypassed in the backward pass to ensure numerically stable training.

In FIG. 3, at block 310 training data is obtained. The training data comprises sequences of transmitted bits of each connected UE 110 and corresponding received signals at each RU 120. In examples the training data may be simulated. The inference model is then initialized. Initializing the inference model may comprise initializing trainable weights, θ, of neural networks of RU DeepRxs 320 and a DU DeepRx 330. According to examples the initialization may comprise setting the weights to random values. One or more samples comprising sequences of transmitted bits and corresponding received signals are selected from the training dataset. The number of samples selected may be based on available memory or training performance.

The batch of Rx signals are parsed through the RU DeepRxs 310 and the DU DeepRx 320 and output LLRs or bit probabilities for each UE are collected. In FIG. 3, the fronthaul data is quantized at block 340.

At block 350 a cross entropy loss between the output of the DU DeepRx 330 and the sequence of transmitted bits is determined as

$$C {E}_{q} ( θ ) = - \frac{1}{{W}_{q}} {\sum }_{i = 0}^{{W}_{q} - 1} ( {b}_{i q} log ( {\hat{b}}_{i q} ) + ( 1 - {b}_{i q} ) log ( 1 - {\hat{b}}_{i q} ) ) \qquad ( I )$$

In equation (1) q is the sample index within the batch, b_{iq} is the transmitted bit, \hat{b}_{iq} is the bit estimated by the DU DeepRx 330, and W_{q} is the total number of transmitted bits. In equation (1) the bits in big contain the bits transmitted by all UEs, although the UE indices are omitted.

At block 350, the cross entropies of equation (1) are summed over the whole batch

$$CE ( θ ) = {\sum }_{q ∈ batch} C {E}_{q} ( θ )$$

At block 360 network parameters θ for the RU DeepRxs 320 and DU DeepRx 330 are updated using for example, stochastic gradient descent (SGD) using a predefined learning rate, based on a calculated gradient of the loss function CE(θ). In some examples the Adam optimizer may be used. The training procedure 300 may be repeated iteratively for batches of samples until a predefined stop condition is met such as a predefined number of iterations being performed or once a threshold cross entropy level is reached.

In some cases, where either the RU(s) 120 or DU 130 are from another vendor ORAN compliance may be desired. In that case the training procedure shown in FIG. 3 may be modified for an ORAN compliant system where the signals transmitted over the fronthaul 140 are in accordance with a desired ORAN split.

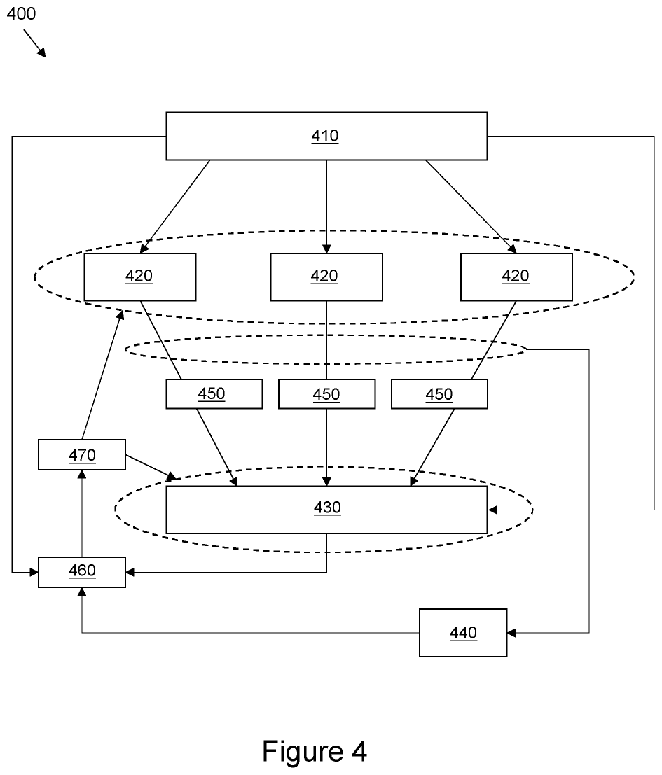

FIG. 4 is a simplified schematic diagram of a training procedure 400 for a training a ORAN compliant system, according to an example. Similarly as the training procedure 300 shown in FIG. 3, the training procedure 400 may be carried out with a stochastic gradient descent (SGD) algorithm, using a binary cross entropy (CE) as the loss function. However in the training procedure 400 an additional loss term is introduced to the loss function for the signals transmitted over the fronthaul link 40. The training procedure 400 yields trained networks for both the RUs 120 and the DU 130, even though one might only require one of those in a cross-vendor deployment.

In FIG. 4, at block 410 training data is obtained. Similarly as the procedure 300 the training data comprises sequences transmitted bits of each connected UE 110 and corresponding received signals at each RU 120. In addition, the received signals are processed with conventional RUs and the outputs are collected as reference signals for the fronthaul link 140. The inference model is then initialized. Initializing the inference model may comprise initializing trainable weights, θ, of neural networks of RU DeepRxs 420 and a DU DeepRx 430. Initialization the trainable weights may comprise setting the weights to random values. One or more samples are then selected from the training dataset comprising of received signals, transmitted bits, and the fronthaul signals between RUs 120 and the DU 130. The number of samples in a batch of samples may be based on available memory or observed training performance.

The batch of Rx signals are parsed through the RU DeepRxs 420 and the DU DeepRx 430 and output LLRs or bit probabilities for each UE are collected. The output signals 440 of each RU DeepRx 420 are also collected. In FIG. 4, the fronthaul data is quantized at block 450.

At block 460 a cross entropy loss between the output of the DU DeepRx 430 and the sequence of transmitted bits is determined as:

$$C {E}_{q} ( θ ) = - \frac{1}{{W}_{q}} {\sum }_{i = 0}^{{W}_{q} - 1} ( {b}_{i q} log ( {\hat{b}}_{i q} ) + ( 1 - {b}_{i q} ) log ( 1 - {\hat{b}}_{i q} ) ) \qquad ( 2 )$$

In equation (2) q is the sample index within the batch, b_{iq} is the transmitted bit, \hat{b}_{iq} is the bit estimated by the DU DeepRx 330, and W_{q} is the total number of transmitted bits.

In addition, at block 460 a mean squared error (MSE) between the RU DeepRx and reference signals from conventional RU outputs is determined as:

$$M S {E}_{q} ( θ ) = \frac{1}{{R}_{q}} {\sum }_{i = 0}^{{R}_{q} - 1} {\vert {y}_{i} - {\hat{y}}_{i} \vert}^{2} \qquad ( 3 )$$

In equation (3) yᵢ denotes the desired fronthaul signal, and ŷᵢ is the output 440 of the RU DeepRx 420. In equation (3) the output signals 440 are concatenated into one vector of length R_{q}, where R_{q} is the combined number of fronthaul samples among all RUs. The cross entropies and MSE losses are summed over the whole batch of samples:

$$L ( θ ) = {\sum }_{q ∈ batch} ( {CE}_{q} ( θ ) + α M S {E}_{q} ( θ ) ) \qquad ( 4 )$$

In equation (4) a represents the multiplier of the MSE loss term.

At block 470 the set of trainable network parameters θ is updated with stochastic gradient descent based on a calculated gradient of the resulting batch loss function L(θ). As with the procedure 300 the training procedure 400 may be repeated iteratively for batches of samples until a predefined stop condition is met such as a predefined number of iterations being performed or once a threshold cross entropy level is reached.

In an alternative example, each RU DeepRx 420 may be trained individually to provide an ORAN-compliant output signal, without training the whole system jointly. The DU DeepRx may also be trained independently using conventional ORAN RU output signals.

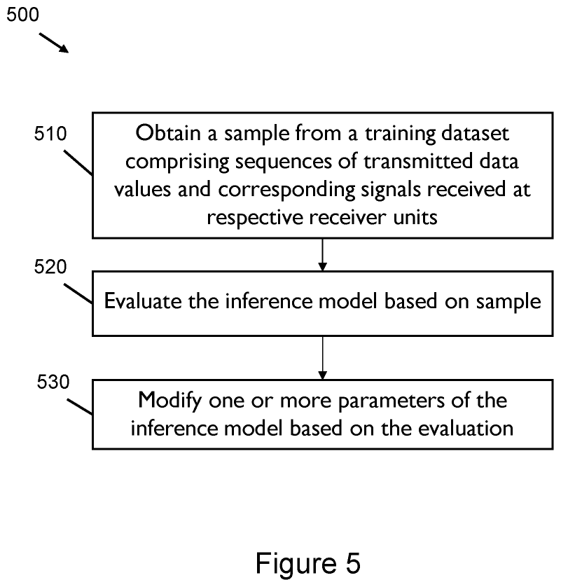

FIG. 5 is a block diagram of a method for training an inference model for an apparatus in a communications network, according to an example. The apparatus comprises at least two receiver units such as RUs 120 shown in FIG. 1. The receivers are configured to receive signals from user equipment (UEs) in the communication network. The apparatus comprises a logical unit such as DU 130 shown in FIG. 1. The logical unit is communicatively coupled to each of the at least two receiver units. The logical unit receives a signal from each of the receiver units and output a sequence of data corresponding to a sequence of transmitted data. The inference model comprises sub-models corresponding to each of the at least two receiver units and a sub-model corresponding to the logical unit. According to examples the inference model may comprise the model 200 shown in FIG. 2.

At block 510 the method comprises obtaining a sample from a training dataset. The training dataset comprises sequences of transmitted data values and corresponding signals received at respective receiver units.

At block 520 the inference model is evaluated based on the sample. In examples, evaluating the inference model comprises evaluating a loss function based on an output of the inference model and the sequence transmitted data values of the sample. The loss function may comprise a cross entropy loss function of the output of the inference model and the sequence of transmitted bits. In some cases, the loss function further comprises a mean squared error function of an output of the sub-models of the at least two receiver units and a reference signal. The reference signal may comprise a fronthaul signal such as that described in reference to FIG. 4.

At block 530 the method 500 comprises modifying one or more parameters of the inference model based on the evaluation. According to examples, modifying one or more parameters of the inference model comprises performing a stochastic gradient descent on the basis of the evaluation.

In some examples, evaluating the inference model comprises evaluating the sub-models corresponding to the at least two receiver units and modifying one or more parameters of the inference model based on the evaluation comprises modifying parameters of the sub-models corresponding to the at least two receiver units based on the evaluation of the respective sub-models. In other examples, evaluating the inference model comprises evaluating the sub-model corresponding to the logical unit and modifying one or more parameters of the inference model based on the evaluation comprises modifying parameters of the sub-model corresponding to the logical unit.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, logic unit, or programmable gate set etc. The methods and modules may all be performed by a single processor or divided amongst several processors. Such machine-readable instructions may also be stored in a computer readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

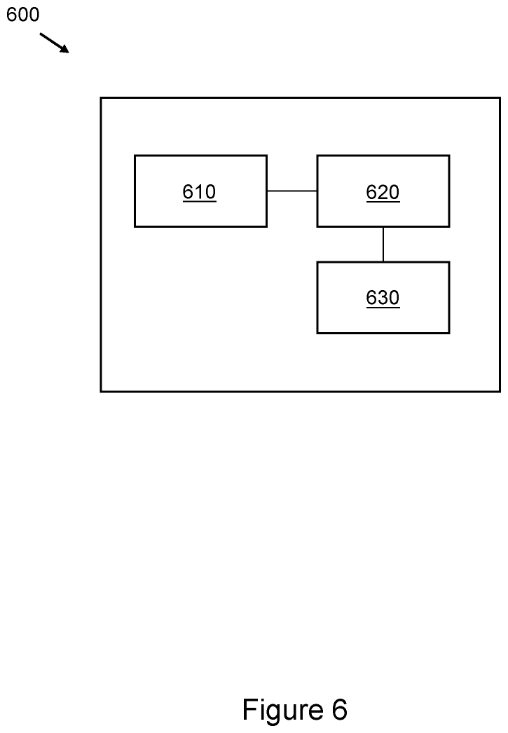

FIG. 6 shows an example of a computing system 600 comprising a processor 610 associated with a memory 620. The memory 620 comprises computer readable instructions 630 which are executable by the processor 610. The instructions 630 cause the processor 610 to obtain a sample from a training dataset, the training dataset comprising sequences of transmitted data values and corresponding signals received at respective receiver units of a communications network. The instructions further cause the processor to evaluate an inference model based on the sample and modify one or more parameters of the inference model based on the evaluation.

Although the present disclosure and its advantages have been described in detail, it should be understood that various changes, substitutions and alterations can be made herein without departing from the spirit and scope of the disclosure as defined by the appended claims.

The present inventions can be embodied in other specific apparatus and/or methods. The described embodiments are to be considered in all respects as illustrative and not restrictive. In particular, the scope of the invention is indicated by the appended claims rather than by the description and figures herein. All changes that come within the meaning and range of equivalency of the claims are to be embraced within their scope.

1. A method for training an inference model for an apparatus in a communications network, the apparatus comprising at least two receiver units configured to receive signals from user equipment in the communication network and a logical unit communicatively coupled to the at least two receiver units, the logical unit configured to receive a signal from the receiver units and output a sequence of data corresponding to a sequence of transmitted data, the method comprising:
obtaining a sample from a training dataset, the training dataset comprising sequences of transmitted data values and corresponding signals received at respective receiver units;
evaluating the inference model based on the sample; and
modifying one or more parameters of the inference model based on the evaluation;
wherein the inference model comprises sub-models corresponding to the at least two receiver units and a sub-model corresponding to the logical unit.

2. The method of claim 1, wherein evaluating the inference model comprises evaluating a loss function based on an output of the inference model and the sequence transmitted data values of the sample.

3. The method of claim 2, wherein the loss function comprises a cross entropy loss function of the output of the inference model and the sequence of transmitted bits.

4. The method of claim 2, wherein modifying one or more parameters of the inference model comprises performing a stochastic gradient descent on the basis of the evaluation.

5. The method of claim 2, wherein the inference model comprises a neural network.

6. The method of claim 5, wherein the sub-models comprise neural networks.

7. The method of claim 6, wherein the loss function further comprises a mean squared error function of an output of the sub-models of the at least two receiver units and a reference signal.

8. The method of claim 7, wherein the reference signal comprises a reference fronthaul signal.

9. The method of claim 1, wherein evaluating the inference model comprises evaluating the sub-models corresponding to the at least two receiver units; and
wherein modifying one or more parameters of the inference model based on the evaluation comprises modifying parameters of the sub-models corresponding to the at least two receiver units based on the evaluation of the respective sub-models.

10. The method of claim 1, wherein evaluating the inference model comprises evaluating the sub-model corresponding to the logical unit; and
wherein modifying one or more parameters of the inference model based on the evaluation comprises modifying parameters of the sub-model corresponding to the logical unit.

11. The method of claim 1, wherein the at least two receiver units are distributed receiver units and the logical unit is a distributed unit in a distributed multiple input multiple output system.

12. A method for an apparatus in a communications network, the apparatus comprising at least two receiver units configured to receive signals from user equipment in the communication network and a logical unit communicatively coupled to the at least two receiver units, the logical unit to receive signals from the receiver units and output a sequence of data corresponding to a sequence of transmitted data, the method comprising:
receiving a signal at the at least two receiver units; and
obtaining a sequence of data based on an output of an inference model that is trained to receive an input comprising a signal received at the at least two receiver units and output a sequence of data corresponding to a sequence of transmitted data from the user equipment;
wherein the inference model comprises sub-models corresponding to the at least two receiver units and a sub-model corresponding to the logical unit.

13. A non-transitory program storage device readable with an apparatus, tangibly embodying a program of instructions executable with the apparatus to cause the computer to carry out the steps of the method of claim 1.

14. A computing system comprising at least one processor and at least one non-transitory memory storing instructions that, when executed with the at least one processor, carry out the steps of the method of claim 1.
